(19) United States
(12) Patent Application Publication
(10) Pub. No.: US 2025/0209488 A1
(43) Pub. Date: Jun. 26, 2025

(54) EFFICIENT ECOMMERCE PLATFORM SHIPPING SYSTEMS

(71) Applicant: 4D Holdings CA, LLC, Valley Village, CA (US)

(72) Inventor: Aaron Marshall, Valley Village, CA (US)

(73) Assignee: 4D Holdings CA, LLC, Valley Village, CA (US)

(21) Appl. No.: 18/395,369

(22) Filed: Dec. 22, 2023

(51) Int. Cl. G06Q 30/0207; G06Q 10/087; G06Q 30/0601

(52) U.S. Cl. CPC G06Q 30/0222; G06Q 10/087; G06Q 30/0635

(57) ABSTRACT

System and methods of the inventive subject matter are directed to improving ecommerce platform efficiencies. By creating incentive structures for ecommerce platforms that account for realities of shipping various quantities of goods, shoppers can be encouraged to purchase more goods, and businesses can be encouraged to promote more efficient shipping practices. Thus, embodiments facilitate application of discounts and the like when users entirely fill capacity-based shipping units in the course of shopping. For example, if a user purchases enough goods to fill a shipping pallet, then the user could be given a discount accordingly. Because an entire pallet is filled, shipping costs can be minimized for the business as shipping logistics are simplified. This efficiency can be passed on to the end user as cash back, discounts, rebates, and so on.

### FIELD OF THE INVENTION

The field of the invention is ecommerce shipping systems.

### BACKGROUND

The background description includes information that may be useful in understanding the present invention. It is not an admission that any of the information provided in this application is prior art or relevant to the presently claimed invention, or that any publication specifically or implicitly referenced is prior art.

Ecommerce platforms have a wide range of shipping incentives they can use to encourage spending. Some of the most popular free shipping incentives include unconditional free shipping, minimum order thresholds, limit-time offers, and free expedited shipping. Unconditional free shipping is straightforward: free shipping for any purchase. Generally, the costs for shipping are then built into product price. Minimum order thresholds require customers to spend a certain dollar amount to qualify for free shipping. Limit-time offers create a sense of urgency, and free expedited shipping can be used to incentivize larger orders or attract customers who value fast delivery.

Some ecommerce platforms offer shipping discounts instead of free shipping. Some examples include flat rate shipping, tiered shipping rates, and percentage-based discounts. Each of these discount schemes offers discounted shipping in some capacity. Flat rate offers a discount for all goods, tiered shipping rates offer discounts based on a dollar amount of goods sold, and percent-based discounts offer shipping discounts as a function of order value.

But all of these incentive structures fail to account for a critical factor in shipping: how those items are shipped in larger quantities. When products are shipped, they are often affixed to pallets or placed into shipping containers. And from a shipping perspective, filling containers completely, or filling pallets completely, is a good way to maximize shipping efficiency. Different goods are different sizes, weights, masses, and shapes, and maximizing dollars spent does not always maximize shipping efficiency, and maximizing shipping efficiency can decrease costs for an ecommerce platform while simultaneously incentivizing increased sales.

Thus, there exists a need in the art for an ecommerce platform that optimizes shipping efficiency in a way that also encourages spending.

### SUMMARY OF THE INVENTION

The present invention provides systems and methods directed to efficient shipping methods for ecommerce platforms. In one aspect of the inventive subject matter, a method of organizing shipping units for an ecommerce platform is contemplated, the method comprising the steps of: adding, by the ecommerce platform, a product to a user shopping cart; adding the product to a capacity-based shipping unit; checking that a fill level of the capacity-based shipping unit exceeds a fill level maximum; displaying the fill level; and applying a discount (such as a shipping discount or a price discount) according to the fill level reaching the fill level maximum.

In some embodiments, the fill level is displayed graphically. The step of adding the product to the capacity-based shipping unit can use at least one of a weight and volume to add to the fill level of the capacity-based shipping unit. In some embodiments, the step of displaying the fill level includes displaying a visualization of the capacity tally, and the visualization can include a fill percent.

In another aspect of the inventive subject matter, a method of organizing shipping units for an ecommerce platform is contemplated, the method comprising the steps of: adding, by the ecommerce platform, a product to a user shopping cart; attempting to add the product to a first capacity-based shipping unit; determining that a fill level of the first capacity-based shipping unit would exceed a threshold fill level by adding the product; adding an overflow product to a second capacity-based shipping unit; displaying an indication that the first capacity-based shipping unit is full; displaying a fill level of the second capacity-based shipping unit; and applying a discount to the first capacity-based shipping unit.

In some embodiments, the second capacity-based shipping unit is the same as the first capacity-based shipping unit (e.g., both are pallets, both are containers, etc.). The step of attempting to add the product to the first capacity-based shipping unit can include using at least one of a weight and volume of the product to determine that the fill level of the first capacity-based shipping unit would exceed the threshold fill level by adding the product. In some embodiments, the step of displaying the fill level of the first capacity-based shipping unit comprises displaying a visualization of the fill level, where the visualization features a fill percent.

In some embodiments, the overflow product is removed from the first capacity-based shipping unit to be added to the second capacity-based shipping unit, and in some embodiments, the overflow product is the product.

In another aspect of the inventive subject matter, a method of organizing shipping units for an ecommerce platform is contemplated, the method comprising the steps of: adding, by the ecommerce platform, a product to a user shopping cart; attempting to add the product to a first capacity-based shipping unit; determining that a fill level of the first capacity-based shipping unit would exceed a threshold fill level by adding the product; upgrading the first capacity-based shipping unit to a second capacity-based shipping unit, where the second capacity-based shipping unit is larger than the first capacity-based shipping unit; adding the product to the second capacity-based shipping unit; displaying a fill level of the second capacity-based shipping unit; and applying a discount for upgrading from the first capacity-based shipping unit to the second capacity-based shipping unit.

In some embodiments, the step of attempting to add the product to the first capacity-based shipping unit includes using at least one of a weight and volume of the product to determine that the fill level of the first capacity-based shipping unit would exceed the threshold fill level by adding the product. In some embodiments, the step of displaying the fill level of the second capacity-based shipping unit includes displaying a visualization of the fill level of the second capacity-based shipping unit, where the visualization comprises a fill percent.

One should appreciate that the disclosed subject matter provides many advantageous technical effects including incentivizing shoppers to improve shipping efficiency. Improving shipping efficiencies is beneficial to the selling business and also to the environment as it reduces shipping costs in terms of dollars as well as carbon impact.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart describing an ecommerce platform of the inventive subject matter generally.

FIG. 2 is a flowchart describing how a user can add a product to their shopping cart using an ecommerce platform of the inventive subject matter.

FIG. 3 is a flowchart describing shipping unit fill logic implemented as a part of the flowchart in FIG. 2.

FIG. 4 is a flowchart describing a checkout process.

FIG. 5 shows an example user interface.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter are directed to an ecommerce platform that is designed to optimize shipping efficiency while simultaneously encouraging consumer spending. Thus, embodiments are directed to systems and methods that encourage customers to completely fill certain shipping vessels, containers, platforms, or the like (such as pallets and shipping containers and collectively referred to as “shipping units”) in order to receive a discount. By giving customers a discount when they have completely filled a shipping unit, sales are increased, and shipping efficiency is increased by eliminated wasted space and by allowing the shipping unit to be delivered to the customer without needing to sort through different products intended for different customers. Improving shipping efficiencies results in reducing a business's carbon footprint as well as its overhead.

In general, embodiments of the inventive subject matter are implemented such that user devices are configured to interact with server computers. User devices can be any kind of computing device accessible to a user that allows the user to communicate with an ecommerce platform of the inventive subject matter. And an ecommerce platform of the inventive subject matter refers to software that is run on, e.g., a cloud computing service or other type of networked computer system that allows for remote execution of software. This architecture allows for an ecommerce platform to be maintained by a service or business separate and apart from the user experience. Users, on the other hand, may access an ecommerce platform via web browser, software application, operating system, or the like. When actions are described in this application, it should be understood that those actions are brought about via ordinary means for ecommerce platform architectures. For example, if a product is added to a shopping cart, it is understood that to do this, a user must select a product to add to their shopping cart, the ecommerce platform receives an instruction from the user device to that effect, and the ecommerce platform reacts by adding that items to the user's cart. This type of hardware-to-hardware communication is inherent throughout this application.

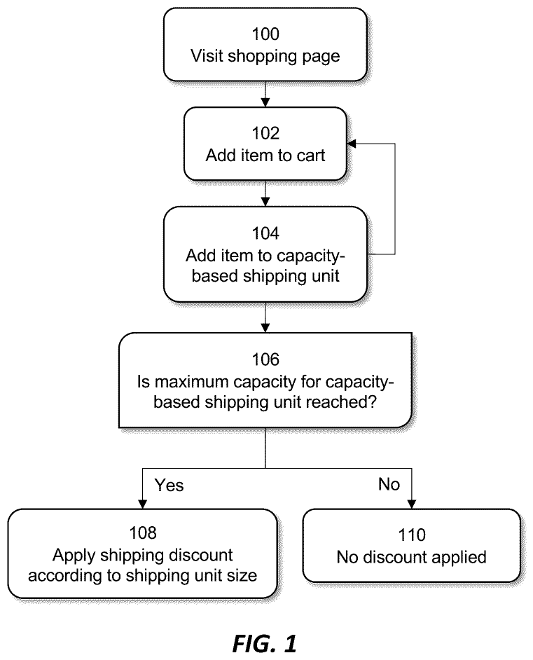

FIG. 1 is a diagram describing the inventive subject matter generally. Embodiments of the inventive subject matter can be implemented into ecommerce platforms in the course of selling goods of any kind that are subject to shipping. Thus, step 100 describes a user visiting a shopping page. A user can access a shopping page via user device, which can be any kind of computing device that has network access and the capability to display an ecommerce shopping page. A shopping page can be visited using, e.g., a dedicated app, a web browser, an operating system, and so on.

Once a user is on a shopping page, they can then add items to their cart, according to step 102. Each item on the shopping page can have metadata associated with it, and that metadata can be maintained in a database that is accessible to the ecommerce platform. Product metadata includes information pertaining to shipping, such as product size, product weight, product mass, and other product information that is relevant to determining shipping method. Other metadata can include product names, product SKUs, product widths, product heights, product lengths, product volumes, and parcel sizes. Product metadata can be used in a number of ways, including to determining whether a capacity-based shipping unit is full.

Other metadata may not exist until later in the process (e.g., when a user checks out to purchase products, additional metadata may come up or become available based on information provided by the user). This other metadata can include shipping addresses, shipping carriers, days in transit, days to fulfill, and shipping rates.

All metadata can be used to, e.g.: negotiate shipping rates on behalf of customers and the ecommerce platform operator; evaluate packaging accuracy; evaluate shipment parcel calculation accuracy; evaluate shipping company transit speed; evaluate shipping company rates, create internal and external evaluation dashboards, where a dashboard provides an overview of information that is captured for customer use.

Once an item is added to the user's cart in step 102, the item is also added to a capacity-based shipping unit in step 104. A capacity-based shipping unit can be any type or means of shipping that can be implemented to move products from one place to another. A capacity-based shipping unit can therefore be as small as a box or as large as a pallet or shipping container. It can be up to each ecommerce platform implementing the inventive subject matter to decide what capacity-based shipping unit should be used. In some embodiments, the capacity-based shipping unit to use can be determined based on discounts that can be achieved by using the selected shipping unit. Which capacity-based shipping unit to use can also be selected based on an ecommerce platform's incentive structure designed to maximize sales revenue.

Once an item has been added to a capacity-based shipping unit in step 104, the user can continue to shop, as indicated by the recursive arrow pointing back to step 102. As each new item added to the user's cart is also added to the capacity-based shipping unit, the ecommerce platform checks, in step 106, whether the maximum capacity for the capacity-based shipping unit has been reached. In some embodiments, this can be a maximum weight, a maximum volume, a maximum product quantity, or the like. If a maximum capacity has been reached, then the ecommerce platform can apply a discount, per step 108. In some embodiments, the discount can be based on the size of the capacity-based shipping unit that is being filled. If the capacity-based shipping unit is not filled, then no discount is applied, per step 110.

In carrying out these steps, systems and methods of the inventive subject matter can be implemented to incentivize additional spending by giving users a discount, where, e.g., the discount can be rooted in economies of scale for shipping prices. For example, although the business using the ecommerce platform may make more money from selling more goods, which would make covering some or all shipping costs make financial sense, it can also be the case that shipping companies may grant discounts to businesses that ship higher volumes or that can pack all goods into a single capacity-based shipping unit that are bound from one destination and going to one other. Other discounts can also be applied, such as rebates and cash back discounts.

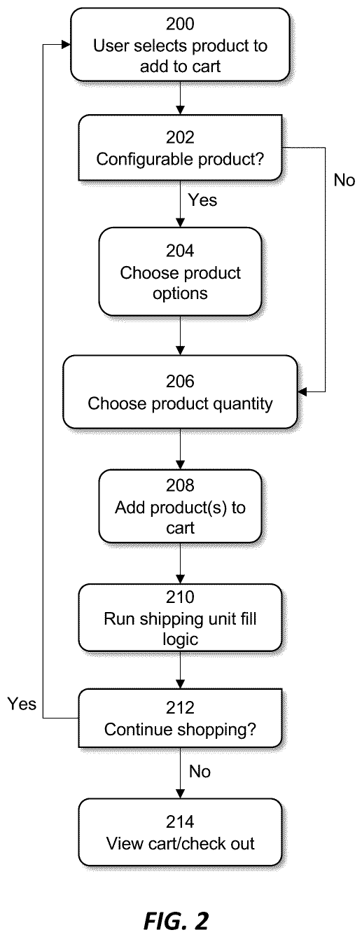

FIG. 2 illustrates an example of how the inventive subject matter can be implemented into product selection and cart management for an ecommerce platform. In step 200, while a user is, e.g., shopping online using an ecommerce platform of some kind, the user clicks a button to add a product to their digital shopping cart. Once a product is selected for addition to the user's cart, the ecommerce platform can run logic based on whether the product is configurable, according to step 202. If the product is configurable, then the user in step 204 is prompted to choose product options before moving to step 206 where the user selects a quantity of the product. If the product is not configurable, then the ecommerce platform moves to step 206, and the user must select a quantity of the product to add to their shopping cart. Once the user has configured the selected product (if applicable) and then selected a quantity, the chosen quantity of the product is placed into the user's shopping cart in step 208.

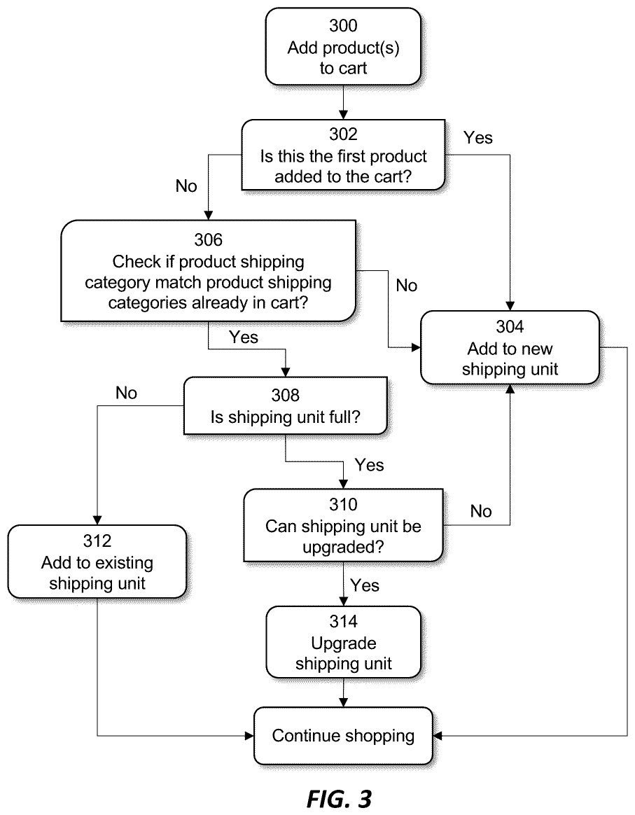

Once these steps are completed, the ecommerce platform then runs capacity-based shipping unit filling logic per step 210. Steps associated with running capacity-based shipping unit filling logic are shown in FIG. 3. Step 300—adding product to a shopping cart-is the last step conducted in FIG. 2 before getting into the capacity-based shipping unit filling logic described in FIG. 3. In step 302, the ecommerce platform checks whether the product to be added to the user's shopping cart is the first item to be added to the cart. If the product is the first, then per step 304, the ecommerce platform adds the product to a new capacity-based shipping unit. If the product is not the first, then the ecommerce platform in step 306 checks whether the product shipping of the product being added to the cart matches the product shipping category of the items already in the cart. Because different items may be subject to different shipping restrictions (e.g., some items must all come from the same location, some items can only be shipped using certain shipping units, and so on), each product should have a shipping category associated with it. Products having the same shipping category can be added to the same capacity-based shipping unit, but if a user tries to add a product to their cart and that product has a different shipping category from the existing products in their cart, the ecommerce platform can add the product to a new capacity-based shipping unit. Thus, if the product's shipping category does not match, then the ecommerce platform goes to step 304 and adds the product to a new capacity-based shipping unit. On the other hand, if the product being added to the cart does match the shipping category of the existing products in the cart, then the ecommerce platform moves to step 308.

In some embodiments, users can provide input indicating how different product selections should be grouped together in a capacity-based shipping unit. An ecommerce platform of the inventive subject matter can implement machine learning software to assess these user provided inputs to then recommend what products should be placed together in a capacity-based shipping unit, especially in cases where multiple capacity-based shipping units exist. Machine learning can give users suggestions, which in turn leads to optimization over time based on, e.g., how often certain suggestions are accepted. For example, over time, a machine learning algorithm could learn that cold or frozen groceries should be grouped together in the same capacity-based shipping unit based on a combination of user provided input and acceptance of machine learning suggestions that raise from those user provided inputs. In another example, a machine learning algorithm could learn over time that heavy products or products should be placed on the bottom of a capacity-based shipping unit, while fragile or lightweight products should be placed at the top.

An edge case that can occur when a user specifies such a quantity of a single product that, even though the product being added to the cart is the first item added to the cart, the capacity-based shipping unit would nevertheless be filled. In such an edge case, the ecommerce platform would first check if the capacity-based shipping unit can be upgraded to accommodate additional capacity. If no upgrades are possible, then the ecommerce platform could add a new capacity-based shipping unit, and for any remaining product that still needs to be fit into a capacity-based shipping unit, additional capacity-based shipping units can be added starting with the smallest capacity-based shipping unit and upgrading as needed. Thus, step 304 can be modified to add as many capacity-based shipping units as needed to accommodate all the product the user has added to their shopping cart.

Otherwise, the ecommerce platform moves to step 308, because the product being added to the cart has the same shipping category as the other products in the cart. At step 308, the ecommerce platform checks if the capacity-based shipping unit is full (e.g., it checks whether the current fill level of the capacity-based shipping unit exceeds a maximum fill level). If the capacity-based shipping unit is filled, then in step 310 the ecommerce platform checks if the capacity-based shipping unit can be upgraded to a larger size. If the capacity-based shipping unit is not filled, then in step 310 the ecommerce platform adds the product to the existing capacity-based shipping unit. In some embodiments, a user can specify a largest capacity-based shipping unit they are willing to accept. This can be beneficial, for example, if a user know they are not capable of receiving shipping containers of products, but that they will be able to handle goods delivered via pallet. Users can also specify minimum capacity-based shipping unit sizes, which can disallow an ecommerce platform of the inventive subject matter from attempting to fill smaller sized capacity-based shipping units.

After checking whether the capacity-based shipping unit can be upgraded to a larger size in step 310, the ecommerce platform either upgrades the capacity-based shipping unit to a larger size in step 314, or, if the capacity-based shipping unit cannot be upgraded to a larger size, the ecommerce platform adds the product to a new capacity-based shipping unit per step 304. After any of steps 312, 314, or 304, the user can then continue shopping, which can entail either adding more products to their cart and going through these processes again or checking out and paying.

In any step where the ecommerce platform checks whether a capacity-based shipping unit has been filled, the platform may be checking a variety of different factors because capacity-based shipping units can be filled according to a variety of measures. For example, capacity-based shipping units can be filled according to weight or volume. When a capacity-based shipping unit is filled according to volume, then each product sold that can be added to the capacity-based shipping unit must have an associated volume, or metadata that can be used to determine volume. For example, if volume is not included for a product, but its shipping dimensions are known, those dimensions can be used to determine the product's volume. When a capacity-based shipping unit is filled according to volume, then each new product added to the user's shopping cart can be used to calculate how much of the capacity-based shipping unit's total capacity has been consumed. The same can be true for weight, because some capacity-based shipping units are filled according to total weight. If weight is not directly provided for a product, then product metadata can be used to determine weight. For example, a product's mass can be used to calculate its weight.

In addition to the dimensions of a product, a product's overall shape can also be considered when making decisions about capacity-based shipping units. For example, if a products overall shape along with its dimensions are included as metadata for the product, then certain capacity-based shipping units may be ruled out for use. For example, if a product is particularly long (e.g., longer than a pallet is wide), then a pallet cannot be used to ship that item. Moreover, irregularly shaped objects may result in open spaces in a capacity-based shipping unit due to the way the irregularly shaped object fits into the capacity-based shipping unit. By accounting for product shape, other products with known shapes may be fit into a capacity-based shipping unit having irregularly shaped products.

Products may also have dimensions associated with them while also being able to ship in a much more compact way as a group than product dimensions might suggest. For example, a single banana may have an average length, height, and width, but a group of bananas does not each take up space according to its individual dimensions-instead, bananas group together and have group dimensions. These group dimensions can be included as metadata, as well.

In some embodiments, capacity-based shipping units are filled according to some function of multiple factors. For example, a capacity-based shipping unit can have both a maximum volume and a maximum weight. Thus, once either of those maximum capacities is reached, the capacity-based shipping unit may be considered full. In still further embodiments, a capacity-based shipping unit may be filled according to a maximum dollar value of products to be shipped. An ecommerce platform can therefore be configured to check one or multiple factors to determine whether a capacity-based shipping unit has reached its maximum capacity.

Container fill logic can be modified by, e.g., a user or an ecommerce platform manager. For example, some ecommerce platforms may want to artificially restrict capacity-based shipping units to a certain size or certain fill level. These attributes of an ecommerce system can be changed manually at any time.

Whether a capacity-based shipping unit is full can be determined in a variety of different ways. Because products being added to a capacity-based shipping unit have different sizes, shapes, weights, and so on, a capacity-based shipping unit will not necessarily need to be completely filled to be considered “full.” For example, if a capacity-based shipping unit is filled to a threshold amount, then the capacity-based shipping unit can be considered full.

The threshold for considering that a capacity-based shipping unit is full can be single- or multivariate. In a single variate example, whether a capacity-based shipping unit is considered full can depend on the weight, mass, or volume (or any other product metadata that can be used in the course of filling a pallet) of a product. Thus, when a capacity-based shipping unit has been filled such that it is holding greater than, say, 95% of its maximum weight capacity, the capacity-based shipping unit can considered full by the ecommerce platform. In a multivariate example, whether a capacity-based shipping unit is full can depend on multiple factors, including any combination of weight, volume, shape, and so on. Thus, when a capacity-based shipping unit is loaded such that any of the relevant variables (where a relevant variable is one that is in consideration for determining fullness) reaches a threshold level, the capacity-based shipping unit is considered full. For example, if a capacity-based shipping unit filled such that it is at 50% of its maximum capacity for weight but it is at 95% of its maximum capacity for volumetric capacity- and the thresholds for each are 90%-then because the volumetric capacity has exceeded its threshold, the capacity-based shipping unit is considered full.

Threshold values for fullness can be set, for example, by an ecommerce platform manager. A manager of the ecommerce platform can decide thresholds for a wide variety of different variables that can be accounted for when determining fullness, and the thresholds can be expressed as a percent, as a magnitude, and so on. Thus, in some embodiments, a fullness threshold can be set as, e.g., a value in the range of 80-100% or it can be set as a value in the range of 100-150 lb. An actual threshold magnitude depends on a total capacity for a given capacity-based shipping unit. In some embodiments, fullness thresholds can be determined by a shipping company that is used by the ecommerce platform. Thus, for any given capacity-based shipping unit that an ecommerce platform uses to ship its products, a third-party company (such as a company responsible for doing the shipping) can provide fullness thresholds.

In some cases, a capacity-based shipping unit may not be entirely full (e.g., the threshold is 95%, but the capacity-based shipping unit is currently filled to 90%), but if a product is added, it would exceed 100%. In such a situation, the ecommerce platform can do a number of different things. It can move smaller items from the capacity-based shipping until to a new capacity-based shipping unit, such that adding the larger (and last product to be added) can fit into the first capacity-based shipping unit to exceed the threshold without overfilling it while adding the smaller items that were removed from the first capacity-based shipping unit to the second capacity-based shipping unit.

Another way to handle the same situation is to just add the newest product to a second capacity-based shipping unit and accept that, despite not exceeding the threshold, the first capacity-based shipping unit should be considered full. This can make sense especially when all items being added to a capacity-based shipping unit are large and exceeding the threshold without overfilling a capacity-based shipping unit is not possible, though this strategy may be implemented more generally.

In some embodiments, both a minimum and a maximum threshold can be set. For example, a capacity-based shipping unit can have a minimum threshold that it must be filled to and a maximum threshold after which no more products can be added to it. When a capacity-based shipping unit has a minimum threshold of 80% and a maximum threshold of 95%, then when capacity-based shipping unit is filled to greater than 80% of its maximum capacity, but less than 95% of its maximum capacity, then the capacity-based shipping unit can be considered full. If that capacity-based shipping unit is filled beyond 95%, then an upgraded capacity-based shipping unit or an additional capacity-based shipping unit is needed. And if that capacity-based shipping unit is filled to between 80% and 95%, then it is considered full. Anything less than 80% would not be considered full.

Once all container fill logic has been run per step 210, the user can continue shopping, as described above and according to step 212. If a user chooses to continue to shop, then the process can start again at step 200, and if a user is done shopping, then they can view their cart, check out, or carry out any number of other actions according to step 214.

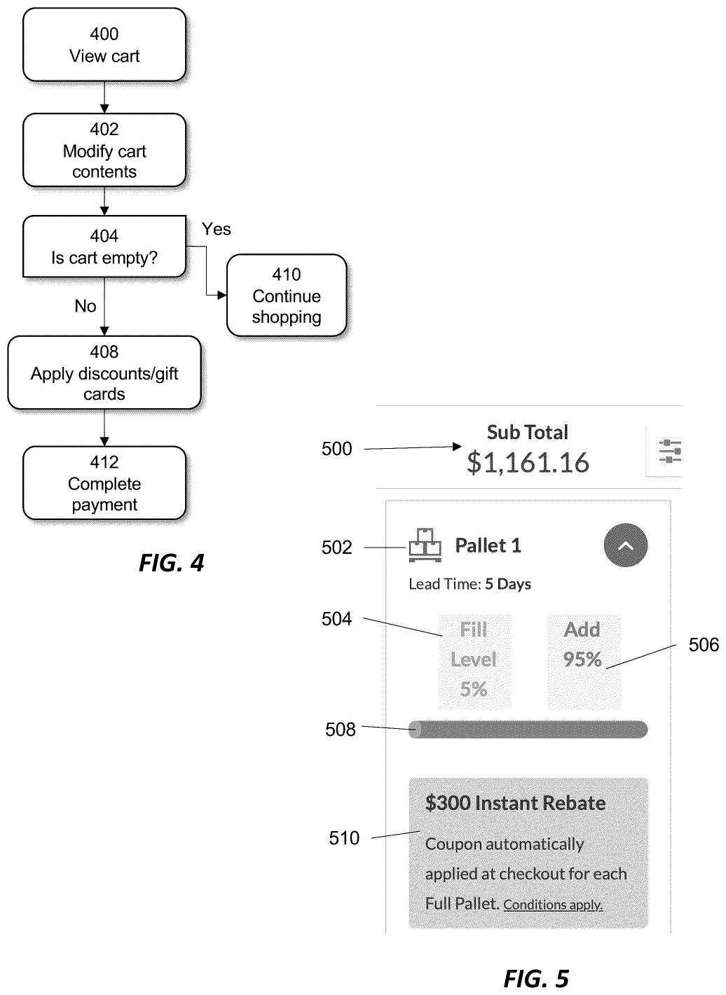

FIG. 4 is a diagram showing what can happen when a user views their shopping cart. In step 400, a user views their cart. This can be accomplished by, e.g., clicking a hyperlink or button that takes the user to a user interface that shows the contents of their shopping cart. From this interface, a user can modify the contents of their cart per step 402. A user can change quantities, remove items, and so on. In some cases, a user may remove all items from a cart, giving rise to a need for the ecommerce platform to check, in step 404, whether the cart is empty. In some cases, there may be no actions for a user to take in step 402 because the cart may already be empty as a user has not yet added any items to their cart. When the ecommerce platform finds in step 404 that the cart is empty, the user can continue shopping per 410. If the cart is not empty, then the ecommerce platform moves to step 408, where discounts, gift cards, or the like can be applied.

In some embodiments, discounts, gift cards, or the like can be applied automatically. For example, discounts applied according to having filled one or more capacity-based shipping units can be applied at this step. Each different business using an ecommerce platform of the inventive subject matter can implement different discount schedules and can set up different discounts that can automatically be applied based on filling different capacity-based shipping units. In some cases, for example, a flat discount can be applied according to what sized capacity-based shipping unit has been filled. In other cases, shipping discounts can be applied according to what sized capacity-based shipping unit has been filled. Discounts can also be determined according to, e.g., a percent of total amount spent and triggered only by completely filled capacity-based shipping units. For example, a user fills one capacity-based shipping unit, but only partially fills a second, the user can be given a discount for the first capacity-based shipping unit but not for the second.

A number of other incentive schemes are also contemplated. For example, in some embodiments, each new capacity-based shipping unit that is filled can be subject to a larger discount from the unit before it. If the first discount is $300, then the discount for the second capacity-based shipping unit (of the same size) could be $400. In another example, a first discount can be applied for a first quantity of filled capacity-based shipping units and a second, larger discount can be applied for each completely filled capacity-based shipping unit thereafter. In yet another example, an ecommerce platform can offer to send a pallet (and its contents, for example) for free once a specified quantity of capacity-based shipping units has been filled. For example, the 10th pallet can be free after a person or business has purchased nine completely-filled capacity-based shipping units. In yet another example, discounts can be applied to all products placed in a capacity-based shipping unit once a specified amount of money is spent or a specified quantity of capacity-based shipping units are filled.

Once discounts, gift cards, and the like have been applied, a user can complete the payment process. This can entail adding a shipping address to estimate taxes and shipping, developing a total cost, having the user check it, choosing a payment method, and proceeding with payment.

FIG. 5 shows an example of a user interface that can be displayed to a user while interacting with a business using an ecommerce platform of the inventive subject matter. The user interface shows a subtotal 500 followed by an indication of the type of capacity-based shipping unit that the user is currently filling 502. Here, the user is filling a pallet. The interface shows a fill indicator 504 that indicates how much of the pallet has been filled, represented as a percent. By representing the fill level as a percent, the ecommerce platform eliminates units that may be confusing for an end user. For example, if the ecommerce platform is determining fill level based on some function of different properties of various products, such as weight or mass and volume, then the percent filled indicator may be more intuitive. In some embodiments, units can be displayed if, for example, it is easier to represent a fill level using a specific unit. The interface also includes a remaining to fill indicator 506 to show how much must still be added to fill the capacity-based shipping unit. This indicator is essentially an inversion of the fill indicator 504. For example, in embodiments where fill level is indicated as a percent, then the remaining to fill indicator 506 is just the fill indicator 504 subtracted from 100%.

In addition to percent indicators, the interface can include a visual indicator 508 of a capacity-based shipping unit's capacity. Visual indicator 508 shows a progress bar representation of fill level indicators 504 and 506, where the bar in visual indicator 508 fills as the capacity-based shipping unit fills. Finally, the interface also includes an incentive indicator 510 showing the incentive that is offered to the user if a capacity-based shipping unit is filled. In this case, if the user filled a pallet, they could get a $300 instant rebate.

Ecommerce platforms of the inventive subject matter can be used by third parties in a variety of ways. For example, a business can access features of ecommerce platforms described in this application by accessing an Application Programming Interface (API). This can allow the business to access any or all the features described in this application. For example, a drop shipping business can incorporate an ecommerce platform of the inventive subject matter into its website using the API. Doing so allows its customers to place orders according to capacity-based shipping units as configured by the drop shipping business.

Embodiments can also be incorporated into existing websites and ecommerce platforms. For example, an existing ecommerce platform can integrate an ecommerce platform of the inventive subject matter into its own API to bring about any or all of the functions described in this application.

Thus, specific systems and methods directed to creating more efficient ecommerce platforms have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of organizing shipping units for an ecommerce platform, the method comprising the steps of:
adding, by the ecommerce platform, a product to a user shopping cart;
adding the product to a capacity-based shipping unit;
checking that a fill level of the capacity-based shipping unit exceeds a fill level threshold;
displaying the fill level; and
applying a discount according to the fill level reaching the fill level threshold.

2. The method of claim 1, wherein the fill level is displayed graphically.

3. The method of claim 1, wherein the discount comprises at least one of a shipping discount and a price discount.

4. The method of claim 1, wherein the step of adding the product to the capacity-based shipping unit comprises using at least one of a weight and volume to add to the fill level.

5. The method of claim 1, wherein the step of displaying the fill level comprises displaying a visualization of the fill level.

6. The method of claim 5, wherein the visualization comprises a fill percent.

7. A method of organizing shipping units for an ecommerce platform, the method comprising the steps of:
adding, by the ecommerce platform, a product to a user shopping cart;
attempting to add the product to a first capacity-based shipping unit;
determining that a fill level of the first capacity-based shipping unit would exceed a maximum fill level by adding the product;
adding an overflow product to a second capacity-based shipping unit;
displaying an indication that the first capacity-based shipping unit is full;
displaying a fill level of the second capacity-based shipping unit; and
applying a discount to the first capacity-based shipping unit.

8. The method of claim 7, wherein the second capacity-based shipping unit is the same as the first capacity-based shipping unit.

9. The method of claim 7, wherein the step of attempting to add the product to the first capacity-based shipping unit comprises using at least one of a weight and volume of the product to determine that the fill level of the first capacity-based shipping unit would exceed the maximum fill level by adding the product.

10. The method of claim 7, wherein the step of displaying the fill level of the first capacity-based shipping unit comprises displaying a visualization of the fill level.

11. The method of claim 10, wherein the visualization comprises a fill percent.

12. The method of claim 7, wherein the overflow product is removed from the first capacity-based shipping unit to be added to the second capacity-based shipping unit.

13. The method of claim 7, wherein the overflow product is the product.

14. A method of organizing shipping units for an ecommerce platform, the method comprising the steps of:
adding, by the ecommerce platform, a product to a user shopping cart;
attempting to add the product to a first capacity-based shipping unit;
determining that a fill level of the first capacity-based shipping unit would exceed a threshold fill level by adding the product;
upgrading the first capacity-based shipping unit to a second capacity-based shipping unit;
wherein the second capacity-based shipping unit is larger than the first capacity-based shipping unit;
adding the product to the second capacity-based shipping unit;
displaying a fill level of the second capacity-based shipping unit; and
applying a discount for upgrading from the first capacity-based shipping unit to the second capacity-based shipping unit.

15. The method of claim 14, wherein the step of attempting to add the product to the first capacity-based shipping unit comprises using at least one of a weight and volume of the product to determine that the fill level of the first capacity-based shipping unit would exceed the threshold fill level by adding the product.

16. The method of claim 14, wherein the step of displaying the fill level of the second capacity-based shipping unit comprises displaying a visualization of the fill level of the second capacity-based shipping unit.

17. The method of claim 16, wherein the visualization comprises a fill percent.
